(19) United States
(12) Patent Application Publication
(10) Pub. No.: US 2013/0306037 A1
(43) Pub. Date: Nov. 21, 2013

(54) DEVICE FOR CONTROLLING A HEAT ENGINE

(71) Applicants: Nicolas Gelez, Le Pecq (FR); Julien Hobraiche, Chevrieres (FR)

(72) Inventors: Nicolas Gelez, Le Pecq (FR); Julien Hobraiche, Chevrieres (FR)

(73) Assignee: VALEO SYSTEMES DE CONTROLE MOTEUR, Cergy Saint Christophe (FR)

(21) Appl. No.: 13/993,877

(22) PCT Filed: Dec. 20, 2011
(86) PCT No.: PCT/FR11/53092

§ 371 Date: Aug. 5, 2013

(30) Foreign Application Priority Data
Dec. 22, 2010 (FR) 1061096

(51) Int. Cl. F02D 13/06; F02D 17/02

(52) U.S. Cl. CPC F02D 13/06; F02D 17/02
USPC 123/481; 123/198 F

(57) ABSTRACT

The invention relates to a device for controlling a heat engine, comprising a plurality of cylinders (1, 2, 3, 4), at least one of which (2, 3) is provided with at least two inlet valves (2a, 2b, 3a, 3b). According to the invention, the device comprises a control unit (5) arranged to deactivate said inlet valves in series.

The invention relates to a device for controlling a heat engine. The heat engine is a four-stroke internal combustion engine that can be used to propel motor vehicles.

Such a heat engine comprises a block in which are defined combustion chambers (or cylinders) that have an end that is sealed by a cylinder head and an opposite end that is sealed by a piston that is received and slides in the block and is connected by a connecting rod to a crankshaft converting the reciprocating translational movement of the piston into a continuous rotary movement. The cylinder head is provided with means for introducing air or an air-fuel mixture into each cylinder and exhaust means for the burnt gases. These means comprise an intake duct and an exhaust duct respectively blocked by intake valves and at least one exhaust valve.

It will be recalled that the overall torque supplied at the output of a heat engine with N cylinders is the sum of the individual torques supplied by the pistons of the N cylinders.

Since the individual torque value depends on the filling of the cylinder with the air-fuel mixture, the individual efficiency of a cylinder of the heat engine increases with the individual torque to be supplied at the output of said cylinder.

It will also be recalled that, for an engine with controlled ignition, the ignition advance of a cylinder is the time difference between the moment when a spark is produced in the chamber of said cylinder and the moment when the piston moving in said cylinder reaches its top dead center point.

### TECHNOLOGICAL BACKGROUND OF THE INVENTION

In order to reduce pollutant emissions, and in particular greenhouse gas emissions, heat engines consuming increasingly less fuel are emerging. On a conventional heat engine, the most polluting operating point is reached when all the cylinders of the engine are operating at partial load. On engines with a high cubic capacity, in particular on V8s, it is thus known practice to cut the supply of fuel to half of the cylinders around these operating points so as to increase the individual load of the remaining cylinders and therefore increase their efficiency, which makes the engine less polluting.

The overall torque supplied at the output of the heat engine with a high cubic capacity is then only slightly discontinuous on the transition from the deactivation of half of the cylinders. In practice, the number of cylinders in the heat engine is high enough for the remaining cylinders to have to provide only a relatively low additional individual load. Thus, if the heat engine is used to propel a car, the driver will not in the least sense this discontinuity in the overall torque.

On the other hand, for an engine with fewer cylinders, if half of the cylinders are deactivated, the remaining cylinders will have to supply a high additional individual load. This will result in a significant jump in torque for each remaining cylinder: the overall torque supplied at the output of the heat engine will then be greatly discontinuous. The driver will necessarily sense the transition from all cylinders active to half the cylinders active.

### OBJECT OF THE INVENTION

One aim of the invention is to at least partly remedy the above mentioned problem.

### BRIEF DESCRIPTION OF THE INVENTION

In order to achieve this aim, there is proposed a device for controlling a heat engine comprising a plurality of cylinders at least one of which is provided with at least two intake valves. According to the invention, the device comprises a control unit arranged to successively deactivate said intake valves.

Thus, the individual torque of each of the active cylinders increases by degree with each deactivation of one of the intake valves of the cylinder to be deactivated. The overall torque supplied at the output of the heat engine is then only slightly discontinuous upon the deactivation of said cylinder, even for an engine of small cubic capacity.

### BRIEF DESCRIPTION OF THE DRAWINGS

The invention will be better understood in light of the following description of a particular nonlimiting embodiment of the invention.

Reference will be made to the appended figures, in which:

FIG. 1 is a highly schematic view of a heat engine comprising a control device of the prior art;

FIG. 2 is a graph illustrating different parameters of the heat engine illustrated in FIG. 1 before, during and after the deactivation of half of the cylinders of the engine;

FIG. 3 is a highly schematic view of a heat engine comprising a control device according to the invention;

FIG. 4 is a graph illustrating different parameters of the heat engine illustrated in FIG. 2 before, during and after the deactivation of half of the cylinders of the engine;

FIG. 5 is a table listing, non-exhaustively, some possible configurations of a cylinder controlled by a control device according to the invention.

### DETAILED DESCRIPTION OF THE INVENTION

With reference to FIG. 3, the control device of the invention is here detailed with reference to a heat engine of a car. The heat engine is here an internal combustion engine comprising an engine block 100 which comprises, in line, a first cylinder 1, a second cylinder 2, a third cylinder 3 and a fourth cylinder 4 (the cylinders being numbered from left to right according to the orientation of FIG. 3) forming combustion chambers each receiving a sliding piston.

The cylinders 1, 2, 3, 4 are linked to an air intake and fuel injection system, and to an exhaust system.

Each cylinder is equipped with a fuel injector and is here equipped with a first intake valve 1a, 2a, 3a, 4a and a second intake valve 1b, 2b, 3b, 4b as well as a first exhaust valve 1c, 2c, 3c, 4c and a second exhaust valve 1d, 2d, 3d, 4d. The intake valves (in white) 1a and 1b, 2a and 2b, 3a and 3b, 4a and 4b link the associated cylinder 1, 2, 3, 4 to the intake system and the exhaust valves (in black) 1c and 1d, 2c and 2d, 3c and 3d, 4c and 4d link the associated cylinder 1, 2, 3, 4 to the exhaust system. Here, the intake valves 1a and 1b, 2a and 2b, 3a and 3b, 4a and 4b and the exhaust valves 1c and 1d, 2c and 2d, 3c and 3d, 4c and 4d are associated with electromagnetic valve actuators, known per se, allowing for individual actuation of the valves such that they can be opened or closed independently of the other valves.

The control device also comprises a control unit 5 or ECU (engine control unit) which determines engine control instructions (such as the quantity of fuel injected and the intake air flow rate) as a function of an acceleration demand from the driver (depression of the accelerator pedal) and the detected values of operating parameters of the engine.

To limit the fuel consumption of the engine, it is known practice to cut the supply of fuel to half of the cylinders around the most polluting operating point of the engine. The individual load of the remaining cylinders, and therefore their efficiency, are thus increased. In the example illustrated, in order to limit a cooling of the cylinders of the engine during a deactivation, priority is given to deactivating the second and the third cylinders 2 and 3. This is because the first and the fourth cylinders 1 and 4 are at the periphery of the engine block, so they provide a better heat distribution toward the centre of the engine block 100 than the second and third cylinders 2 and 3 toward the peripheries of the engine block 100.

According to the invention, the control unit 5 is arranged so as to successively deactivate the intake valves 2a and 2b of the second cylinder 2 and successively deactivate the intake valves 3a and 3b of the third cylinder 3.

To this end, the control device comprises a first device 7 for managing the valve actuators of the first intake valve 2a and of the first exhaust valve 2c of the second cylinder 2 as well as the valve actuators of the second intake valve 3b and of the second exhaust valve 3d of the third cylinder 3. The control device also comprises a second device 8 for managing the valve actuators of the second intake valve 2b and of the second exhaust valve 2d of the second cylinder 2 as well as the valve actuators of the first intake valve 3a and of the first exhaust valve 3c of the third cylinder 3.

The control unit 5 is thus arranged in such a way as to generate, initially, a valve closure signal intended for the first managing device 7 to deactivate the first intake valve 2a and the first exhaust valve 2c of the second cylinder 2 as well as the second intake valve 3b and the second exhaust valve 3d of the third cylinder 3. In a second stage, the control unit 5 generates a valve closure signal intended for the second managing device 8 to deactivate the second intake valve 2b and the second exhaust valve 2d of the second cylinder 2 as well as the first intake valve 3a and the first exhaust valve 3c of the third cylinder 3.

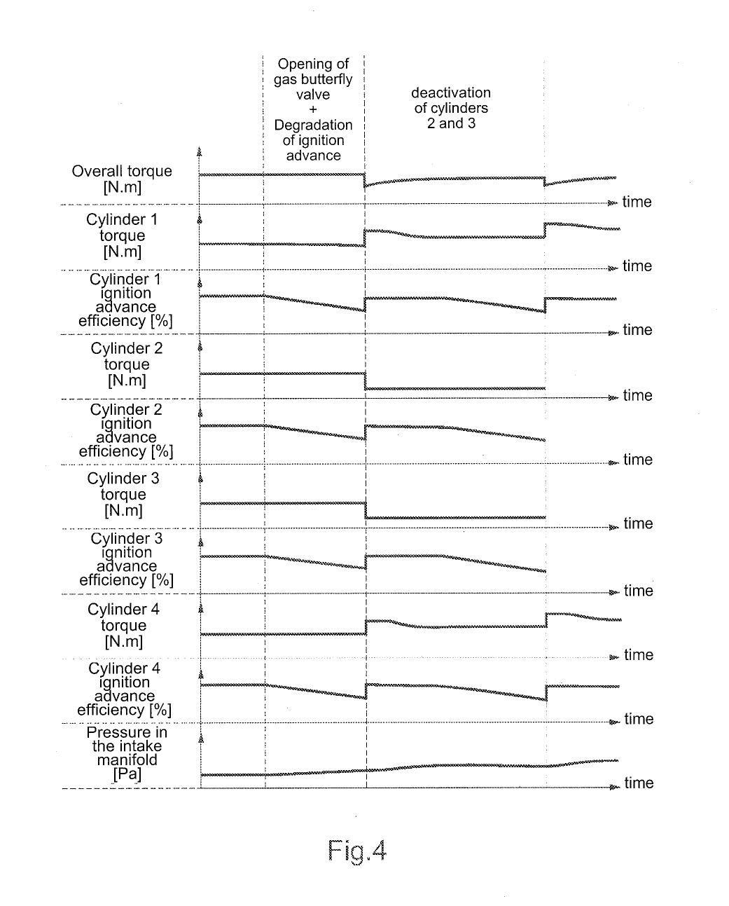

The deactivation of the second and third cylinders 2 and 3 is thus carried out gradually. The two cylinders are initially completely active, then half active, then completely deactivated. With reference to FIG. 4, the individual torque of the second and third cylinders 2, 3 thus decreases by degrees with each deactivation of one of the intake valve-exhaust valve sets and the individual torque of the first cylinder and of the fourth cylinder 1, 4 then increases by degrees. The overall torque supplied at the output of the heat engine is affected only by two weak jumps in torque during the transition from four cylinders active to two cylinders active. Thus, the driver of the car will have little or no sense of this slight discontinuity in the overall torque.

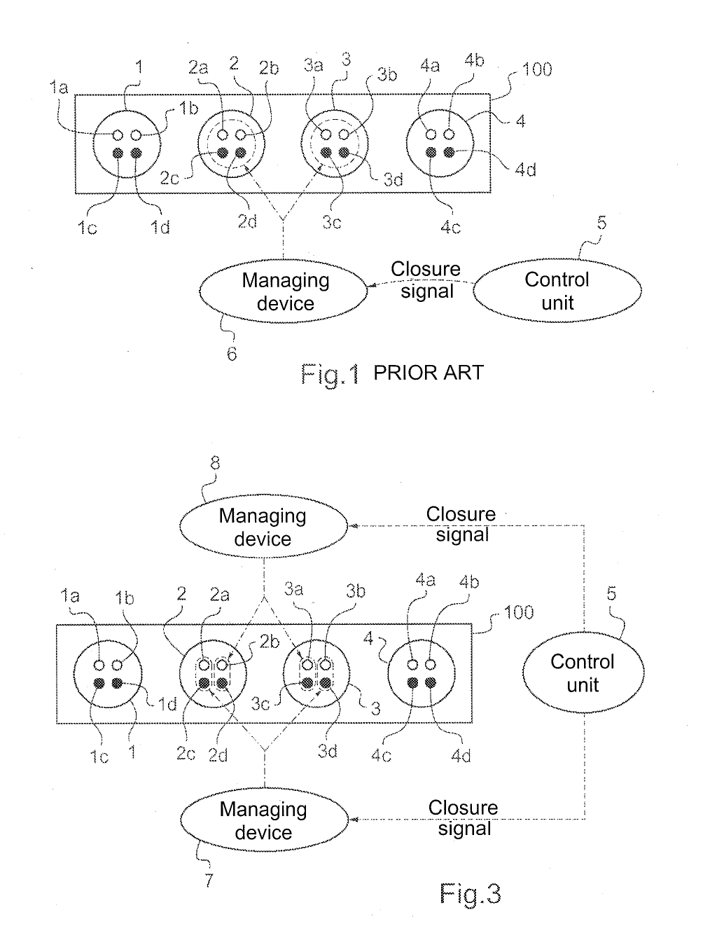

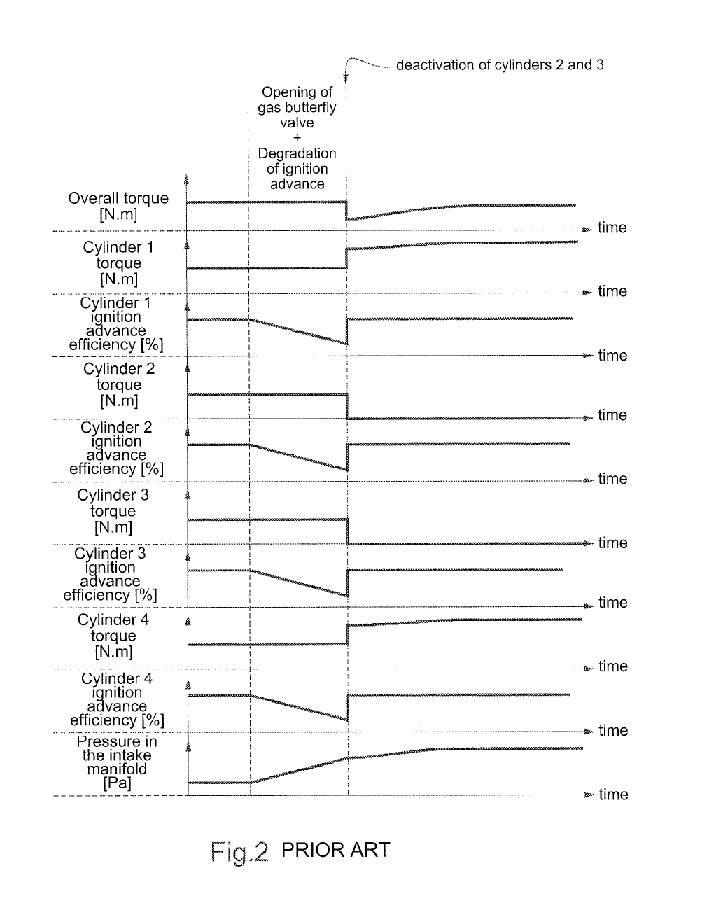

By contrast, referring to FIG. 1, in a control device of the prior art (the references are the same for the elements that are common to the control device of the prior art and of the invention), the control unit 5 generates a valve closure signal intended for a single managing device 6 managing the valve actuators of the second and third cylinders 2 and 3 to simultaneously deactivate the intake valves 2a and 2b, 3a and 3b and the exhaust valves 2c and 2d, 3c and 3d of the second and third cylinders 2 and 3. With reference to FIG. 2, the deactivation of the second and third cylinders 2, 3 is then abrupt and results in a significant jump in torque which is necessarily felt by the driver.

With reference to FIGS. 3 and 4, according to a preferred embodiment, to further limit the discontinuity of the overall torque upon the deactivation of the second and third cylinders 2, 3, the control device is arranged in such a way as to anticipate the deactivation of the intake and exhaust valves 2a, 2b, 2c, 2d and 3a, 3b, 3c, 3d of the second and third cylinders 2 and 3 by commanding an opening of a butterfly valve for the gases from the heat engine and simultaneously a degradation of the ignition advance of the four cylinders of the heat engine.

In practice, if the butterfly valve for the gases were opened only once the second and third cylinders 2, 3 are deactivated, the overall torque would decrease greatly before reverting to its initial value, since the pressure in the intake manifold of the engine cannot increase instantaneously. In parallel, to compensate for the increase in the pressure in the intake manifold due to the opening of the gas butterfly valve, the ignition advance of all of the cylinders is degraded so as to lower the individual efficiency of all of the cylinders. At the time of the deactivation of the second and third cylinders 2, 3, the optimum ignition advance is then restored for the first and fourth cylinders 1, 4.

With reference to FIGS. 1 and 2, it would also be possible, with the prior art device, to anticipate the simultaneous deactivation of the intake and exhaust valves of the second and third cylinders 2 and 3 by commanding an opening of the heat engine gas butterfly valve and, simultaneously, a degradation of the ignition advance of all of the cylinders of the heat engine. However, with the second and third cylinders 2 and 3 being deactivated simultaneously, it would be necessary to open the gas butterfly valve more and therefore degrade the ignition advance of all of the cylinders more than with the control device of the invention. The degradation of the ignition advance would then promote more emissions of pollutants and in particular of carbon dioxide.

The invention is not limited to what has just been described and encompasses any variant falling within the framework defined by the claims.

In particular, although here the control device is associated with a heat engine with four cylinders, the control device will be able to be associated with any type of heat engine. The invention will thus be able to be applied to an engine without controlled ignition such as a diesel engine or even an engine of greater cubic capacity. It will also be possible to apply the invention to an engine in which the cylinders have mutually different configurations, provided that the cylinder or cylinders to be deactivated has/have at least two intake valves. The invention will also be able to be used with any system that allows individual actuation of the valves such as hydraulic actuators.

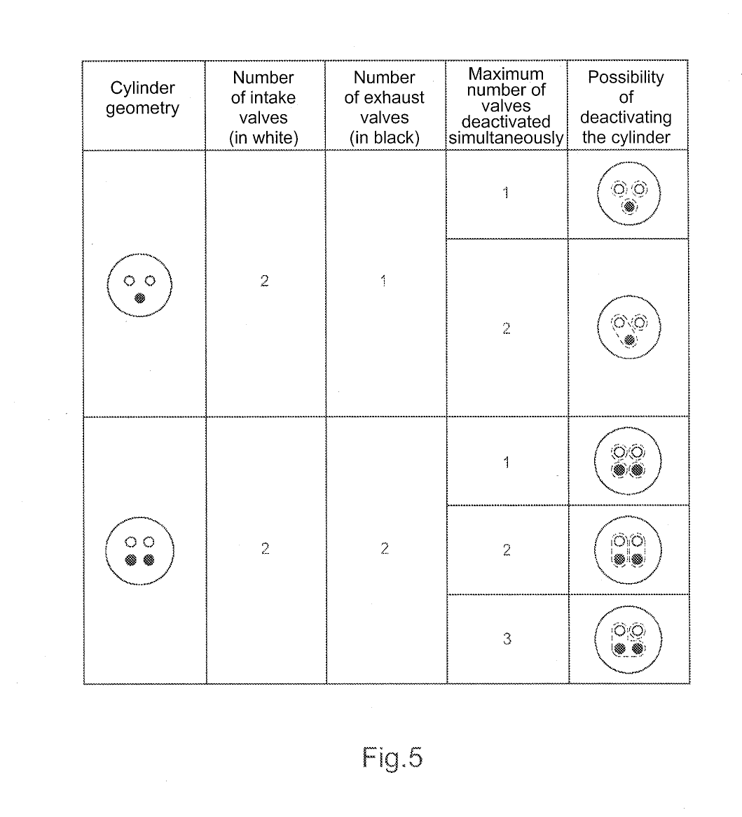

Furthermore, the invention can be applied to any cylinder configuration provided that the cylinder or cylinders to be deactivated has/have at least two intake valves. With reference to FIG. 5, various cylinder geometries for which the invention can be applied are illustrated. Dotted lines indicate valve sets, the valves inside these dotted lines having to be simultaneously deactivated and the sets in dotted lines having to be successively deactivated by the control unit 5. Thus, although here the control unit 5 is arranged to simultaneously deactivate an exhaust valve with an intake valve of one and the same cylinder, the control unit 5 will be able to deactivate the exhaust valve(s) independently of the intake valves. If the cylinder has at least two exhaust valves, said exhaust valves will also be able to be deactivated simultaneously with one and the same intake valve of the cylinder. FIG. 5 illustrates only some of the various possibilities of deactivation of a cylinder according to the invention. Thus, a cylinder to be deactivated will be able to have a greater number of intake or exhaust valves.

Furthermore, although here the control unit 5 is arranged to deactivate intake valves and exhaust valves, the control unit 5 will be able to be arranged in such a way as to deactivate only the intake valves. However, in a preferred embodiment, intake valves and exhaust valves will be deactivated to maintain a high pressure in the deactivated cylinder. In practice, if the pressure in the deactivated cylinders decreases gradually, it ends up being less than atmospheric pressure: oil is thus sucked from the sump into the deactivated cylinders. This oil will then be burned and the polluting products from the combustion will be expelled by the exhaust system when said cylinders are next invoked.

1. A device for controlling a heat engine, comprising:
a plurality of cylinders at least one of which is provided with at least two intake valves; and
a control unit arranged to successively deactivate said intake valves.

2. The control device as claimed in claim 1, arranged to anticipate the deactivation of said intake valves by commanding an opening of a butterfly valve for the gases from the heat engine and a degradation of the ignition advance of all the cylinders of the heat engine.

3. The control device as claimed in claim 1, wherein said cylinder comprises at least one exhaust valve, the control unit being arranged to also deactivate the at least one exhaust valve.

4. The control device as claimed in claim 3, wherein the control unit is arranged to deactivate the exhaust valve simultaneously with one of the two intake valves.

5. The control device as claimed in claim 1, wherein the heat engine comprises four cylinders, at least two cylinders each comprising a first set formed by an intake valve and an exhaust valve and a second set formed by an intake valve and an exhaust valve, the control unit being arranged to simultaneously deactivate the first set of valves of the first cylinder and of the second cylinder then simultaneously deactivate the second set of valves of the first cylinder and of the second cylinder.
